(19) United States
(12) Patent Application Publication
(10) Pub. No.: US 2022/0097456 A1
(43) Pub. Date: Mar. 31, 2022

(54) TIRE

(71) Applicant: The Yokohama Rubber Co., LTD., Tokyo (JP)

(72) Inventor: Takahide ISHIZAKA, Kanagawa (JP)

(21) Appl. No.: 17/448,436

(22) Filed: Sep. 22, 2021

(30) Foreign Application Priority Data
Sep. 30, 2020 (JP) 2020-166417

(51) Int. Cl. B60C 11/03; B60C 11/24

(52) U.S. Cl. CPC B60C 11/0309; B60C 11/24; B60C 2011/0355; B60C 2011/0351; B60C 2011/0353; B60C 2011/0348

(57) ABSTRACT

A tire includes a circumferential narrow main groove extending in a tire circumferential direction provided in a tread portion. The circumferential narrow main groove includes a narrow groove portion having a groove width W1 in a range of 1.0 mm≤W1≤4.0 mm in a region where a groove depth from a road contact surface of the tread portion is less than 30%, and a widened portion having a maximum groove width W2 more widened than the groove width W1 in a region where the groove depth is 30% or more.

### CROSS-REFERENCE TO RELATED APPLICATIONS

This application claims priority pursuant to 35 U.S.C. 119(a) to Japanese Patent Application No. 2020-166417, filed Sep. 30, 2020, which application is incorporated herein by reference in its entirety.

### TECHNICAL FIELD

The present technology relates to a tire in which a circumferential groove is provided in a tread portion.

### BACKGROUND ART

Tires using block patterns in the tread portion generally have excellent wet traction performance. In this type of tire, a pneumatic tire is known in which for the purpose of suppressing noise and improving uneven wear resistance, for example, circumferential main grooves are disposed in a tread portion in a zigzag shape so that the zigzag is shifted in the circumferential direction (for example, see Japan Unexamined Patent Publication No. 2012-076658).

Incidentally, in order to improve the rolling resistance (RRC; Rolling Resistance Coefficient), a configuration has been sought, in which a rib row, which is defined by a plurality of circumferential grooves, are divided by lug narrow grooves or sipes to have a rib-based block pattern, and block rows are disposed in a concentrated manner at a center portion with the circumferential grooves as narrow grooves.

On the other hand, in the configuration described above, since the groove volume is reduced and the drainage properties are deteriorated, there is a concern that the wet traction performance inherent in the block pattern is reduced. In the conventional pneumatic tire described above, there is a room for improvement in suppressing a decrease in the wet traction performance while improving the rolling resistance.

### SUMMARY

The present technology provides a tire capable of suppressing a decrease in the wet traction performance while improving the rolling resistance.

A tire according to an embodiment of the present technology is a tire including at least one circumferential groove extending in a tire circumferential direction in a tread portion. The circumferential groove includes a narrow groove portion having a groove width W1 in a range of 1.0 mm≤W1≤4.0 mm in a region where a groove depth from a surface of the tread portion is less than 30%, and a widened portion having a maximum groove width W2 more widened than the groove width W1 in a region where the groove depth is 30% or more.

In the tire described above, preferably, when the circumferential groove is divided into two parts at a position where the groove depth is 50%, a ratio (A2/A1) of a groove bottom-side cross-sectional area A2 to a groove opening-side cross-sectional area A1 in a tire meridian cross-section of the circumferential groove is in a range of 1.5≤(A2/A1)≤4.0.

In the tire described above, preferably, the maximum groove width W2 of the widened portion is in a range of 3.0 mm≤W2≤8.0 mm.

In the tire described above, preferably, the ratio (W2/W1) of the maximum groove width W2 of the widened portion to the groove width W1 in the region where the groove depth is less than 30% is in a range of 1.5≤(W2/W1)≤4.0.

In the tire described above, preferably, a relationship between the groove width W3 of the widened portion at which the groove depth is 80%, the maximum groove width W2 of the widened portion, and the groove width W1 of the narrow groove portion satisfies W1<W3≤W2 and 3.0 mm≤W3.

In the tire described above, preferably, the widened portion has an oblong shape in which a length H3 in a tire radial direction is larger than the maximum groove width W2, and a ratio (H3/W2) of the length H3 in the tire radial direction to the maximum groove width W2 is in a range of 0.8≤(H3/W2)≤2.0.

In the tire described above, preferably, a ratio (H3/H1) of the length H3 of the widened portion in the tire radial direction to the groove depth H1 of the circumferential groove is in a range of 0.30≤(H3/H1)≤0.70.

In the tire described above, preferably, the circumferential groove includes a wear indicator in the widened portion.

In the tire described above, the tire preferably includes two circumferential main grooves extending in a tire circumferential direction in the tread portion. And the circumferential groove is disposed between the two circumferential main grooves.

In the tire described above, the tire preferably includes a land portion defined by the circumferential groove and the circumferential main groove. And a ratio (TWc/TW) of a width TWc in a tire width direction of an arrangement range of the land portion to a tread development width TW is in a range of 0.55≤(TWc/TW)≤0.70.

In the tire described above, preferably, the circumferential main groove has a wider groove width than the circumferential groove, and a groove width W4 of the circumferential main groove is in a range of 8.0 mm≤W4≤15.0 mm.

In the tire described above, the tire preferably includes a plurality of lug narrow grooves connecting the circumferential groove and the circumferential main groove and extending in the tire width direction. A groove width W5 of the lug narrow groove is in a range of 0.5 mm≤W5≤2.0 mm, and a ratio (H5/H1) of a groove depth H5 of the lug narrow groove to the groove depth H1 of the circumferential groove is in a range of 0.45≤(H5/H1)≤0.90.

In the tire according to an embodiment of the present technology, the circumferential groove includes a narrow groove portion having a groove width W1 in a range of 1.0 mm≤W1≤4.0 mm in a region where a groove depth from a surface of the tread portion is less than 30%, and a widened portion having a maximum groove width W2 more widened than the groove width W1 in a region where the groove depth is 30% or more. And thus, it is possible to suppress a decrease in wet traction performance while improving rolling resistance.

### BRIEF DESCRIPTION OF DRAWINGS

FIG. 1 is a meridian cross-sectional view illustrating main parts of a pneumatic tire according to an embodiment.

FIG. 2 is a developed view illustrating a tread pattern of a pneumatic tire.

FIG. 3 is a schematic view illustrating a cross-sectional shape of a circumferential narrow main groove formed in a tread portion.

FIG. 4 is a schematic view illustrating a cross-sectional shape of a circumferential narrow main groove and a circumferential main groove formed in a tread portion.

FIG. 5 is a table showing the results of performance tests of pneumatic tires according to the present embodiment.

### DETAILED DESCRIPTION

Embodiments of the present technology are described in detail below with reference to the drawings. In the embodiments described below, identical or substantially similar components to those of other embodiments have identical reference signs, and descriptions of those components are either simplified or omitted. The present technology is not limited by the embodiments. Constituents of the embodiments include elements that are substantially identical or that can be substituted and easily conceived by one skilled in the art.

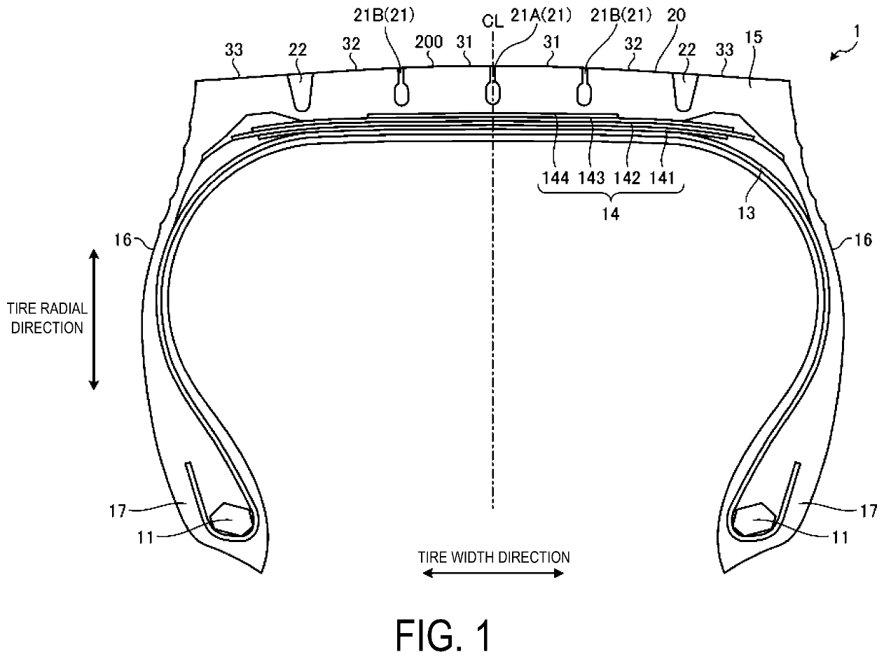

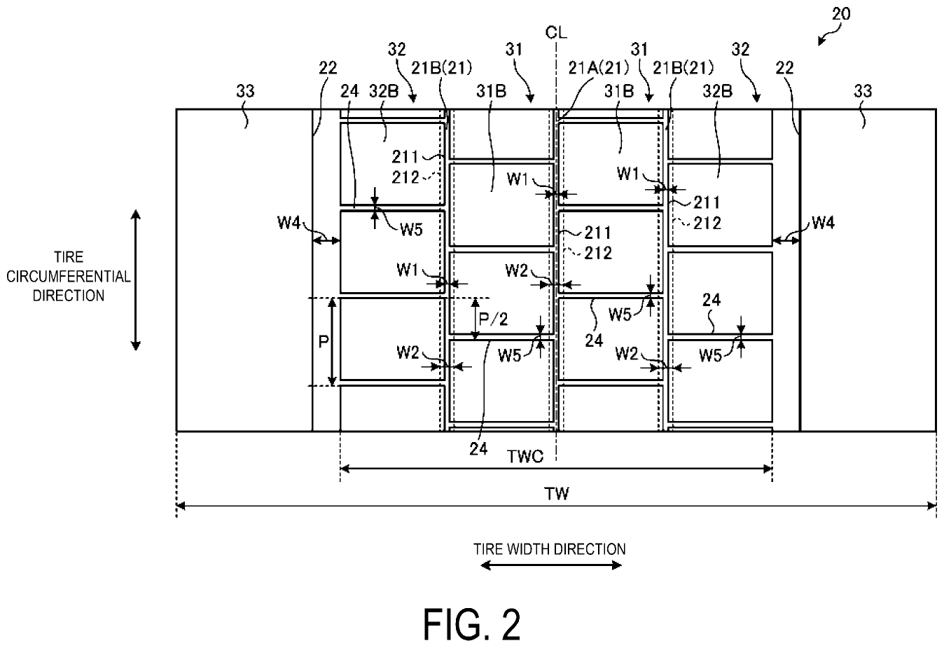

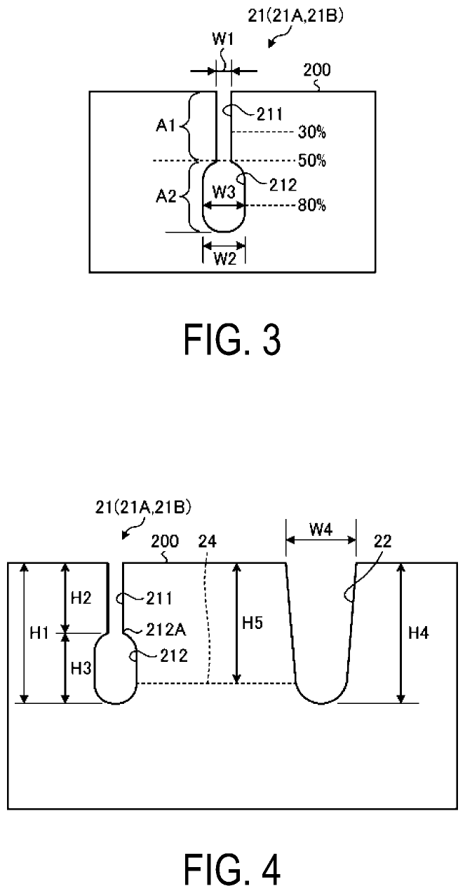

FIG. 1 is a meridian cross-sectional view illustrating main parts of a pneumatic tire according to the present embodiment. FIG. 1 illustrates a cross-sectional view of a half region of a pneumatic tire 1 (hereinafter sometimes referred to simply as a tire 1) in the tire radial direction. FIG. 2 is a developed view illustrating a tread pattern of a pneumatic tire. FIG. 3 is a schematic view illustrating a cross-sectional shape of a circumferential narrow main groove formed in a tread portion. FIG. 4 is a schematic view illustrating a cross-sectional shape of a circumferential narrow main groove and a circumferential main groove formed in a tread portion. In the following description, the meridian cross-section refers to a cross-section when a tire is cut on a plane including a tire rotation axis (not illustrated). Further, the reference sign CL is a tire equatorial plane, and refers to a plane that passes through the center point of the tire in the tire rotation axis direction and is perpendicular to the tire rotation axis. Additionally, the tire width direction refers to a direction parallel with the tire rotation axis, the inner side in the tire width direction refers to the side toward the tire equatorial plane CL in the tire width direction, and the outer side in the tire width direction refers to the side away from the tire equatorial plane CL in the tire width direction. The tire radial direction refers to a direction perpendicular to the tire rotation axis, the inner side in the tire radial direction refers to the side toward the rotation axis in the tire radial direction, and the outer side in the tire radial direction refers to the side away from the rotation axis in the tire radial direction.

As illustrated in FIG. 1, a pneumatic tire 1 includes a pair of bead cores 11, 11, a carcass layer 13, a belt layer 14, a tread rubber 15 that constitutes a tread portion 20, sidewall rubbers 16, 16 that constitute left and right sidewall portions, and rim cushion rubbers 17, 17 that constitute left and right bead portions. The surface of the tread portion 20 forms a part of the contour of the pneumatic tire 1, and is formed as a road contact surface 200 that contacts the road surface when the vehicle travels. The belt layer 14 has a structure in which a plurality of belt plies are layered. In FIG. 1, the belt layer 14 has a structure in which a large-angle belt 141, a pair of cross belt plies 142 and 143, and a belt cover 144 are layered. A bead filler may be provided on the outer side in the tire radial direction of the bead core 11. Note that the tire internal structure described above represents a typical example for a pneumatic tire, but the pneumatic tire is not limited thereto.

As illustrated in FIG. 2, the road contact surface 200 of the tread portion 20 is provided with a first circumferential narrow main groove (circumferential groove) 21A extending in the tire circumferential direction at a position of the tire equatorial plane CL, a pair of second circumferential narrow main grooves (circumferential grooves) 21B extending in the tire circumferential direction at positions further on the outer side in the tire width direction than the first circumferential narrow main groove 21A on both sides of the tire equatorial plane CL, and a pair of circumferential main grooves 22 extending in the tire circumferential direction at positions further on the outer side in the tire width direction than the second circumferential narrow main groove 21B. Preferably, the second circumferential narrow main groove 21B and the circumferential main groove 22 are disposed in left-right symmetry with respect to the tire equatorial plane CL. Note that, in a case where the first circumferential narrow main groove 21A and the second circumferential narrow main groove 21B are not distinguished, they are simply referred to as the circumferential narrow main groove 21.

The first circumferential narrow main groove 21A, the second circumferential narrow main groove 21B, and the circumferential main groove 22 are five circumferential main grooves each extending in the tire circumferential direction, and include a wear indicator defined by JATMA (The Japan Automobile Tyre Manufacturers Association, Inc.) in the groove bottom. The pair of circumferential main grooves 22 are circumferential grooves located on the outermost side in the tire width direction and have a wider (larger) groove width than the three circumferential narrow main grooves 21 disposed between the circumferential main grooves 22, 22. The groove width is the distance between opposing wall surfaces of the groove, and in a case where the opening portion of the groove is chamfered, the distance between the intersection points assumed between the extension line of the road contact surface 200 and the extension lines of the wall surfaces of the groove is defined as the groove width. The groove width W1 of the circumferential narrow main groove 21 when the tire is new is preferably 1.0 mm or more and 4.0 mm or less, and more preferably 1.5 mm or more and 3.0 mm or less. Additionally, the circumferential main groove 22 is the groove having the greatest groove width in the circumferential grooves formed in the tread portion 20. The groove width W4 of the circumferential main groove 22 when the tire is new is preferably 8.0 mm or more and 15.0 mm or less, and more preferably 10 mm or more and 13 mm or less. In the present embodiment, three circumferential narrow main grooves 21 are provided. However, it is sufficient that at least one circumferential narrow main groove 21 is provided between the circumferential main grooves 22, 22. In this case, preferably, one circumferential narrow main groove 21 is provided at the position of the tire equatorial plane CL (center in the tire width direction) or in the vicinity of the position of the tire equatorial plane CL.

The tread portion 20 is divided into the plurality of land portions by forming the first circumferential narrow main groove 21A, the second circumferential narrow main groove 21B, and the circumferential main groove 22. Specifically, in the tread portion 20, a first land portion 31 extending in the tire circumferential direction is formed between the first circumferential narrow main groove 21A and the second circumferential narrow main groove 21B. The first land portion 31 is divided into a plurality of blocks 31B by lug narrow grooves 24 extending in the tire width direction. In other words, the first land portion 31 includes a plurality of blocks 31B divided by the lug narrow grooves 24 and arranged in the tire circumferential direction. The lug narrow groove 24 connects the adjacent first circumferential narrow main groove 21A and second circumferential narrow main groove 21B, or the adjacent second circumferential narrow main groove 21B and circumferential main groove 22, and have a groove width equal to or less than the width of the circumferential narrow main groove 21. Specifically, the groove width W5 of the lug narrow groove 24 when the tire is new is preferably 0.5 mm or more and 3.0 mm or less, and more preferably 1.0 mm or more and 2.0 mm or less. This lug narrow groove 24 may be configured as a sipe.

Additionally, in the tread portion 20, a second land portion 32 extending in the tire circumferential direction is formed between the second circumferential narrow main groove 21B and the circumferential main groove 22. The second land portion 32 is divided into a plurality of blocks 32B by the lug groove 24 extending in the tire width direction. In other words, the second land portion 32 includes a plurality of blocks 32B divided by the lug narrow grooves 24 and arranged in the tire circumferential direction.

Additionally, in the tread portion 20, a shoulder land portion 33 extending in the tire circumferential direction is formed on the outer side in the tire width direction of the circumferential main groove 22. The shoulder land portion 33 is located in the shoulder portion of the tread portion 20. The shoulder land portion 33 may include a plurality of shoulder lug grooves (not illustrated) having one end connected to the circumferential main grooves 22 and extending in the tire width direction and may be divided into a plurality of shoulder blocks by the shoulder lug grooves. In this case, the groove width of the shoulder lug groove is wider (larger) than the groove width W5 of the lug narrow groove 24, and is preferably 2.0 mm or more and 5.0 mm or less, for example.

In the example of FIG. 2, the tread portion 20 includes the lug narrow grooves 24 all extending in the tire width direction and a plurality of rectangular blocks 31B, 32B, and the plurality of blocks 31B, 32B are disposed in a staggered manner to form a block pattern. Specifically, the blocks 31B, 31B adjacent to each other with the first circumferential narrow main groove 21A in between are disposed to be shifted by ½ pitch (P/2) in the tire circumferential direction, and the blocks 31B, 32B adjacent to each other with the second circumferential narrow main groove 21B in between are also disposed to be shifted by ½ pitch (P/2) in the tire circumferential direction. Here, the pitch P refers to the distance when the blocks 31B, 32B are repeatedly disposed in the tire circumferential direction, and is the sum of the distance of the blocks 31B, 32B and the groove width of the lug narrow groove 24 in the tire circumferential direction. Additionally, the block pattern of the tread portion 20 is not limited to that shown in FIG. 2, and all lug narrow grooves 24 may be inclined with respect to the tire width direction. For example, the first land portion 31 and the second land portion 32 on both sides with the tire equatorial plane CL in between may be inclined with respect to the tire width direction so that the inclination direction of the lug narrow grooves 24 is V-shaped.

In this configuration, the tread portion 20 defines the first land portion 31 and the second land portion 32 by the first circumferential narrow main groove 21A and the second circumferential narrow main groove 21B having a narrower groove width W1 than the groove width W4 of the circumferential main groove 22. As a result, when the tire 1 contacts the ground, the first circumferential narrow main groove 21A and the second circumferential narrow main groove 21B are closed, and the adjacent blocks 31B, 32B act as a wide block, whereby rolling resistance can be reduced. Furthermore, for the adjacent first land portions 31 or the adjacent first land portion 31 and second land portion 32, each of the blocks 31B, 32B are disposed being shifted in the tire circumferential direction. And thus, the lug narrow grooves 24 are prevented from communicating with each other, and noise when the tire 1 contacts the ground can be reduced. Additionally, since the lug narrow grooves 24 have the groove width W5 equal to or less than the groove width W1 of the circumferential narrow main groove 21, the traction performance can be improved while reducing the rolling resistance. Additionally, since the circumferential main groove 22 is the main groove located on the outermost side in the tire width direction, it has less influence on rolling resistance than the circumferential narrow main groove 21 disposed on the center side. In this configuration, by setting the groove width W4 of the circumferential main groove 22 to 8.0 mm or more and 15.0 mm or less, the wet traction performance can be improved without deteriorating the rolling resistance.

In the tread portion 20, the ratio (TWc/TW) of the length TWc in the tire width direction of the arrangement range of the blocks 31B, 32B to the tread development width TW is preferably in the range of 0.55 or more and 0.70 or less, and more preferably 0.60 or more and 0.65 or less. By setting the ratio (TWc/TW) to the range of 0.55 or more and 0.70 or less, it is possible to form a tread pattern in which block rows are disposed as concentrating in the center portion of the tread portion 20. As a result, the rigidity of the tread portion 20 can be increased, and the effect of reducing rolling resistance can be improved.

Here, the length TWc is the length in the tire width direction between the pair of circumferential main grooves 22, 22, and is the sum of the width of the four block rows (the first land portion 31 and the second land portion 32) and the groove width W1 of three circumferential narrow main grooves 21. In other words, the length TWc refers to the linear distance between the pair of circumferential main grooves 22, 22 of the tread portion 20 of the tire 1 in a developed view, in a state in which the tire 1 is mounted on a specified rim and inflated to a specified internal pressure, and no load is applied. The tread development width TW is the distance in the tire width direction between both ends on the outer side in the tire width direction of two shoulder land portions 33. The tread development width TW refers to the linear distance between both ends of the tread portion 20 of the tire 1 in a developed view, in a state in which the tire 1 is mounted on a specified rim and inflated to a specified internal pressure, and no load is applied. “Specified rim” refers to an “applicable rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organisation (ETRTO). Additionally, “specified internal pressure” refers to a “maximum air pressure” defined by JATMA, to the maximum value in “TIRE LOAD LIMITS AT VARIOUS COLD INFLATION PRESSURES” defined by TRA, or to “INFLATION PRESSURES” defined by ETRTO. Additionally, “specified load” refers to a “maximum load capacity” defined by JATMA, the maximum value in “TIRE LOAD LIMITS AT VARIOUS COLD INFLATION PRESSURES” defined by TRA, or “LOAD CAPACITY” defined by ETRTO.

Incidentally, as described above, in this configuration, in order to reduce the rolling resistance of the tire 1, the tread portion 20 has a configuration in which the first land portion 31 and the second land portion 32 are defined by the first circumferential narrow main groove 21A and the second circumferential narrow main groove 21B having the narrower groove width W1 than the groove width W4 of the circumferential main groove 22. On the other hand, in the configuration described above, since the groove volume of the circumferential narrow main groove 21 is reduced, and the drainage properties are deteriorated, there is a concern that the wet traction performance inherent in the block pattern is deteriorated. And thus, as illustrated in FIG. 3, the circumferential narrow main groove 21 has a stepped groove shape including a narrow groove portion 211 and a widened portion 212 disposed further on the groove bottom side (the inner side in the tire radial direction) than the narrow groove portion 211 and having a wider groove width than the narrow groove portion 211.

As illustrated in FIG. 4, the groove depth H1 of the circumferential narrow main groove 21 when the tire is new is formed to be equivalent to the groove depth H4 of the circumferential main groove 22. Specifically, the ratio (H1/H4) of the groove depth H1 to the groove depth H4 is 0.95 or more and 1.05 or less. And thus, the circumferential narrow main groove 21 ensures the drainage properties together with the circumferential main groove 22 at the terminal stages of wear, whereby the wet traction performance can be improved. Additionally, the ratio (H5/H1) of the groove depth H5 of the lug narrow groove 24 to the groove depth H1 of the circumferential narrow main groove 21 is 0.45 or more and 0.90 or less. By providing the lug narrow grooves 24 having a narrow groove width in this range, it is possible to suppress a decrease in the wet traction performance without deteriorating the rolling resistance even in a state of being worn to some extent.

The narrow groove portion 211 of the circumferential narrow main groove 21 is a portion in a region of less than 30% of the groove depth H1 of the circumferential narrow main groove 21 from the surface of the tread portion 20 when the tire is new. In other words, the groove depth H2 of the narrow groove portion 211 is set to be less than 30% of the groove depth H1 from the surface of the tread portion 20 in the circumferential narrow main groove 21 when the tire is new. The groove width W1 of the narrow groove portion 211 is preferably 1.0 mm or more and 4.0 mm or less. When the groove width W1 is less than 1.0 mm, since drainage properties are deteriorated, the traction performance when traveling on wet road surfaces such as in rainy weather (hereinafter referred to as wet traction performance) is deteriorated. On the other hand, if the groove width W1 is larger than 4.0 mm, the rigidity of the block rows adjacent to the circumferential narrow main groove 21 in between will decrease, and the rolling resistance deteriorates. In this configuration, by setting the groove width W1 of the narrow groove portion 211 to 1.0 mm or more and 4.0 mm or less, the circumferential narrow main grooves 21 are closed when the tire 1 contacts the ground and the groove walls support each other. And thus, the block rigidity can be improved, whereby the energy loss in the groove bottom portion and the rolling resistance can be reduced. The groove width W1 of the narrow groove portion 211 is more preferably 1.5 mm or more and 3.0 mm or less.

The widened portion 212 is a portion in a region of 30% or more of the groove depth H1 of the circumferential narrow main groove 21 from the surface of the tread portion 20 when the tire is new. In this configuration, the widened portion 212 has a maximum groove width W2 that is wider than the groove width W1 of the narrow groove portion 211. In this way, since the circumferential narrow main groove 21 is provided with the widened portion 212 that is wider than the narrow groove portion 211 in a region of 30% or more of the groove depth H1 from the surface of the tread portion 20 when the tire is new, the drainage properties are improved due to the water entering the widened portion 212, and a decrease in the wet traction performance can be suppressed.

Specifically, the maximum groove width W2 of the widened portion 212 is preferably 3.0 mm or more and 8.0 mm or less. If the maximum groove width W2 is less than 3.0 mm, the decrease in wet traction performance cannot be sufficiently suppressed. On the other hand, if the maximum groove width W2 is larger than 8.0 mm, since the rigidity of the block rows adjacent to the circumferential narrow main groove 21 in between is reduced, the rolling resistance deteriorates. Additionally, if the maximum groove width W2 is larger than 8.0 mm, since the degree of widening with respect to the groove width W1 of the narrow groove portion 211 is excessively large, processing of the circumferential narrow main groove 21 is difficult and productivity will be deteriorated. By setting the maximum groove width W2 of the widened portion 212 to 3.0 mm or more and 8.0 mm or less, it is possible to decrease the rolling resistance and suppress a decrease in wet traction performance in a compatible manner. The maximum groove width W2 of the widened portion 212 is more preferably 4.0 mm or more and 6.5 mm or less.

Additionally, as illustrated in FIG. 3, when the circumferential narrow main groove 21 is divided into two parts in the tire radial direction at the position of 50% of the groove depth H1 from the surface of the tread portion 20 when the tire is new, the ratio (A2/A1) of a groove bottom-side cross-sectional area A2 to a groove opening-side cross-sectional area A1 in the tire meridian cross-section is 1.5 or more and 4.0 or less. The groove opening-side cross-sectional area A1 is mainly the cross-sectional area of the narrow groove portion 211, and the groove bottom-side cross-sectional area A2 is mainly the cross-sectional area of the widened portion 212. If the ratio (A2/A1) is less than 1.5, since the groove bottom-side cross-sectional area A2, that is, the cross-sectional area (volume) of the widened portion 212, becomes relatively small, the reduction in wet traction performance cannot be sufficiently suppressed. On the other hand, if the ratio (A2/A1) is larger than 4.0, since the cross-sectional area (volume) of the widened portion 212 becomes relatively large, the rigidity of the block rows adjacent to the circumferential narrow main groove 21 in between will decrease, and the rolling resistance will be deteriorated. By setting the ratio (A2/A1) to 1.5 or more and 4.0 or less, it is possible to reduce the rolling resistance and suppress a reduction in the wet traction performance in a compatible manner. Furthermore, the ratio (A2/A1) is more preferably 2.0 or more and 3.0 or less.

Additionally, in the circumferential narrow main groove 21, the relationship between the groove width W3 of the widened portion 212 at the position of 80% of the groove depth H1 from the surface of the tread portion 20 when the tire is new, the maximum groove width W2 of the widened portion 212, and the groove width W1 of the narrow groove portion 211 satisfy W1<W3≤W2, and the groove width W3 is preferably 3.0 mm or more. According to this configuration, even at the terminal stages of wear, in which up to 80% of the groove depth H1 from the surface of the tread portion 20 is worn, since the groove width W3 of the widened portion 212 (circumferential narrow main groove 21) can be set to 3.0 mm or more, the water drainage properties of the circumferential narrow main groove 21 can be maintained, and the wet traction performance can be improved. Note that in this configuration, the position of the maximum groove width W2 of the widened portion 212 is located further on the outer side in the tire radial direction than the position of 80% of the groove depth H1 from the surface of the tread portion 20, and specifically, is located in a region of 30% or more and 80% or less of the groove depth H1 from the surface of the tread portion 20 when the tire is new.

As illustrated in FIG. 4, the widening starting point 212A of the widened portion 212 is provided in a region of 30% or more and 70% or less of the groove depth H1 from the surface of the tread portion 20 when the tire is new. If the position of the widening starting point 212A is less than 30% of the groove depth H1 from the surface of the tread portion 20, the rigidity of block rows adjacent to the circumferential narrow main groove 21 in between decreases, and the rolling resistance deteriorates. Further, if the position of the widening starting point 212A is in a region larger than 70% of the groove depth H1 from the surface of the tread portion 20, the deterioration of the wet traction performance cannot be sufficiently suppressed. By providing the widening starting point 212A in a region in the range of 30% or more and 70% or less of the groove depth H1 from the surface of the tread portion 20 when the tire is new, it is possible to reduce the rolling resistance and suppress a reduction in the wet traction performance in a compatible manner.

Additionally, in the circumferential narrow main groove 21, the ratio (W2/W1) of the maximum groove width W2 of the widened portion 212 to the groove width W1 of the narrow groove portion 211 is preferably in the range of 1.5 or more and 4.0 or less. If the ratio (W2/W1) is less than 1.5, the reduction in the wet traction performance cannot be sufficiently suppressed. On the other hand, if the ratio (W2/W1) is larger than 4.0, since the rigidity of block row adjacent to the circumferential narrow main groove 21 in between is reduced, the rolling resistance will deteriorate. Additionally, if the ratio (W2/W1) is larger than 4.0, since the degree of widening of the maximum groove width W2 of the widened portion 212 with respect to the groove width W1 of the narrow groove portion 211 is excessively large, processing of the circumferential narrow main groove 21 is difficult and productivity will be deteriorated. By setting the ratio (W2/W1) to 1.5 or more and 4.0 or less, it is possible to reduce the rolling resistance and suppress a reduction in the wet traction performance in a compatible manner. The ratio W2/W1 is more preferably 0.15 or more and 0.30 or less.

In the present embodiment, the widened portion 212 of the circumferential narrow main groove 21 has an oblong shape in which the groove depth (length in the tire radial direction) H3 when the tire is new is longer than the maximum groove width W2. Specifically, the ratio (H3/W2) of the groove depth H3 to the maximum groove width W2 is preferably 0.8 or more but 2.0 or less. In this configuration, by forming the widened portion 212 into an oblong shape that is long in the tire radial direction, it is possible to ensure the groove cross-sectional area without excessively widening the maximum groove width W2. As a result, it is possible to reduce the rolling resistance and suppress a reduction in the wet traction performance in a compatible manner. Note that the oblong shape includes an elliptical shape, an oval shape, and an egg shape.

Additionally, the ratio (H3/H1) of the groove depth H3 of the widened portion 212 to the groove depth H1 of the circumferential narrow main groove 21 when the tire is new is preferably 0.30 or more and 0.70 or less. If the ratio (H3/H1) is less than 0.30, the water drainage properties of the widened portion 212 cannot be sufficiently ensured, and it is not possible to suppress a reduction in the wet traction performance. If the ratio (H3/H1) is larger than 0.70, the rigidity of block rows adjacent to the circumferential narrow main groove 21 in between is reduced, and the rolling resistance will deteriorate. In this configuration, the ratio (H3/H1) is in a range of 0.30 or more and 0.70 or less, it is possible to reduce the rolling resistance and suppress a reduction in the wet traction performance in a compatible manner.

### EXAMPLES

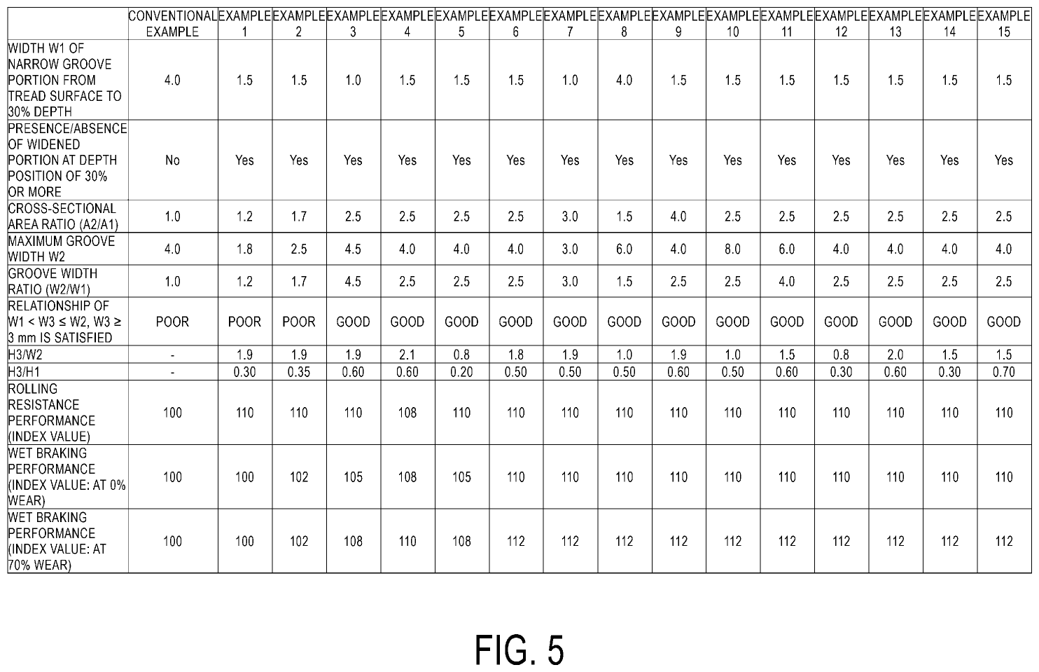

FIG. 5 is a table showing the results of performance tests of pneumatic tires according to the present embodiment. In the performance test, the rolling resistance performance and the wet traction performance were evaluated for a plurality of types of test tires. Note that, the wet traction performance is evaluated when the circumferential narrow main groove 21 is new (worn 0%) and worn 70%. The size of the pneumatic tire 1 used for evaluation is 315/70R22.5. The vehicle used for evaluation is a vehicle in which a trailer is connected to a 6×4 tractor.

An indoor drum testing machine is used to evaluate the rolling resistance performance. In the evaluation of the rolling resistance performance, the test tires are inflated to the specified internal pressure, and the resistance at a load of 31.26 kN and a speed of 80 km/h is measured. The measurement results are expressed as index values and evaluated with Conventional Example being assigned as the reference (100). In the evaluation, larger index values indicate less rolling resistance and thus superior rolling resistance performance.

In the evaluation of wet traction performance, the test tire is mounted on a rim of 22.5×9.00, inflated to an air pressure of 900 kPa, and mounted on a drive shaft of a tractor head, and the wet braking performance is evaluated. In the evaluation of wet braking performance, the deceleration G is measured in a test course when a test vehicle having the test tire mounted thereon decelerates from an initial speed of 60 km/h to 20 km/h on a road surface with water sprayed to a depth of approximately 1 mm. The measured decelerations G are expressed as index values and evaluated with Conventional Example being assigned as the reference (100). In the evaluation, larger values indicate shorter braking distance and superior wet braking performance, that is, wet traction performance. The tire of the conventional example includes a tread portion in which the circumferential narrow main groove does not include a widened portion.

As illustrated in FIG. 5, in the tires 1 of Examples 1 to 15, the groove width W1 of the narrow groove portion 211, the ratio (A2/A1) of the groove bottom-side cross-sectional area A2 to the groove opening-side cross-sectional area A1, the maximum groove width W2 of the widened portion 212, the ratio (W2/W1) of the maximum groove width W2 to the groove width W1, the ratio (H3/W2) of the length H3 of the widened portion 212 in the tire radial direction to the maximum groove width W2, and the ratio (H3/H1) of the length H3 in the tire radial direction to the groove depth H1 of the circumferential narrow main groove 21 differ one another.

As the result of the performance evaluation tests performed using these pneumatic tires 1, as illustrated in FIG. 5, it can be understood that satisfactory results are obtained when the groove width W1 is in the range of 1.0 mm or more and 4.0 mm or less, when the ratio (A2/A1) of the groove bottom-side cross-sectional area A2 to the groove opening-side cross-sectional area A1 is 1.5 or more and 4.0 or less, when the maximum groove width W2 is in the range of 3.0 mm or more and 8.0 mm or less, when the ratio (W2/W1) of the maximum groove width W2 to the groove width W1 is in the range of 1.5 or more and 4.0 or less, when the relationship between the groove width W3 of the widened portion 212 at a groove depth of 80%, the maximum groove width W2, and the groove width W1 satisfies W1<W3≤W2 and the groove width is 3.0 mm or more, when the ratio (H3/W2) of the length H3 in the tire radial direction of the widened portion 212 to the maximum groove width W2 is 0.8 or more and 2.0 or less, and when the ratio (H3/H1) of the length H3 in the tire radial direction to the groove depth H1 of the circumferential narrow main groove 21 is in the range of 0.30 or more and 0.70 or less.

Embodiments of the present technology have been described above, but the present technology is not limited to the embodiments described above. For example, in the present embodiment, a pneumatic tire has been described as an example of a tire, but the present technology is not limited to this, and the present embodiment can naturally be applied to a tire that is not filled with air, such as an airless tire. In addition, inert gas such as nitrogen, argon, and helium in addition to ordinary air or air with an adjusted oxygen partial pressure can be used as the gas to be filled in the pneumatic tire illustrated in the present embodiment.

1. A tire comprising at least one circumferential groove extending in a tire circumferential direction in a tread portion, wherein
the circumferential groove comprises
a narrow groove portion having a groove width W1 in a range of 1.0 mm≤W1≤4.0 mm in a region where a groove depth from a surface of the tread portion is less than 30%, and
a widened portion having a maximum groove width W2 more widened than the groove width W1 in a region where the groove depth is 30% or more.

2. The tire according to claim 1, wherein when the circumferential groove is divided into two parts at a position where the groove depth is 50%, a ratio (A2/A1) of a groove bottom-side cross-sectional area A2 to a groove opening-side cross-sectional area A1 in a tire meridian cross-section of the circumferential groove is in a range of 1.5≤(A2/A1)≤4.0.

3. The tire according to claim 1, wherein the maximum groove width W2 of the widened portion is in a range of 3.0 mm≤W2≤8.0 mm.

4. The tire according to claim 1, wherein a ratio (W2/W1) of the maximum groove width W2 of the widened portion to the groove width W1 in the region where the groove depth is less than 30% is in a range of 1.5≤(W2/W1)≤4.0.

5. The tire according to claim 1, wherein a relationship between a groove width W3 of the widened portion at which the groove depth is 80%, the maximum groove width W2 of the widened portion, and the groove width W1 of the narrow groove portion satisfies W1<W3≤W2 and 3.0 mm≤W3.

6. The tire according to claim 1, wherein
the widened portion has an oblong shape in which a length H3 in a tire radial direction is larger than the maximum groove width W2, and
a ratio (H3/W2) of the length H3 in the tire radial direction to the maximum groove width W2 is in a range of 0.8≤(H3/W2)≤2.0.

7. The tire according to claim 6, wherein a ratio (H3/H1) of the length H3 of the widened portion in the tire radial direction to the groove depth H1 of the circumferential groove is in a range of 0.30≤(H3/H1)≤0.70.

8. The tire according to claim 1, wherein the circumferential groove comprises a wear indicator in the widened portion.

9. The tire according to claim 1, comprising two circumferential main grooves extending in a tire circumferential direction in the tread portion, wherein
the circumferential groove is disposed between the two circumferential main grooves.

10. The tire according to claim 9, further comprising a land portion defined by the circumferential groove and the circumferential main groove, wherein
a ratio (TWc/TW) of a width TWc in a tire width direction of an arrangement range of the land portion to a tread development width TW is in a range of 0.55≤(TWc/TW)≤0.70.

11. The tire according to claim 9, wherein the circumferential main groove has a wider groove width than the circumferential groove, and a groove width W4 of the circumferential main groove is in a range of 8.0 mm≤W4≤15.0 mm.

12. The tire according to claim 9, further comprising a plurality of lug narrow grooves connecting the circumferential groove and the circumferential main groove and extending in a tire width direction, wherein
a groove width W5 of the lug narrow groove is in a range of 0.5 mm≤W5≤2.0 mm, and
a ratio (H5/H1) of a groove depth H5 of the lug narrow groove to the groove depth H1 of the circumferential groove is in a range of 0.45≤(H5/H1)≤0.90.

13. The tire according to claim 12, wherein the maximum groove width W2 of the widened portion is in a range of 3.0 mm≤W2≤8.0 mm.

14. The tire according to claim 13, wherein the ratio (W2/W1) of the maximum groove width W2 of the widened portion to the groove width W1 in the region where the groove depth is less than 30% is in a range of 1.5≤(W2/W1)≤4.0.

15. The tire according to claim 14, wherein a relationship between the groove width W3 of the widened portion at which the groove depth is 80%, the maximum groove width W2 of the widened portion, and the groove width W1 of the narrow groove portion satisfies W1<W3≤W2 and 3.0 mm≤W3.

16. The tire according to claim 15, wherein
the widened portion has an oblong shape in which a length H3 in a tire radial direction is larger than the maximum groove width W2, and
a ratio (H3/W2) of the length H3 in the tire radial direction to the maximum groove width W2 is in a range of 0.8≤(H3/W2)≤2.0.

17. The tire according to claim 16, wherein a ratio (H3/H1) of the length H3 of the widened portion in the tire radial direction to the groove depth H1 of the circumferential groove is in a range of 0.30≤(H3/H1)≤0.70.

18. The tire according to claim 17, wherein the circumferential groove comprises a wear indicator in the widened portion.

19. The tire according to claim 18, comprising two circumferential main grooves extending in a tire circumferential direction in the tread portion, wherein
the circumferential groove is disposed between the two circumferential main grooves.

20. The tire according to claim 19, further comprising a land portion defined by the circumferential groove and the circumferential main groove, wherein
a ratio (TWc/TW) of a width TWc in a tire width direction of an arrangement range of the land portion to a tread development width TW is in a range of 0.55≤(TWc/TW)≤0.70.
